(19) United States
(12) Patent Application Publication
(10) Pub. No.: US 2026/0291945 A1
(43) Pub. Date: Sep. 24, 2026

(54) USER PROFILE MANAGEMENT

(71) Applicant: CELEBRUS TECHNOLOGIES PLC, Sunbury-on-Thames (GB)

(72) Inventors: Anthony PHILLIPS, Sunbury-on-Thames Middlesex (GB); Aravinth SUNDARAM, Sunbury-on-Thames Middlesex (GB); Lincoln GOLDSPINK, Sunbury-on-Thames Middlesex (GB)

(21) Appl. No.: 18/874,334

(22) PCT Filed: Jun. 13, 2022
(86) PCT No.: PCT/GB2022/051485

§ 371 Date: Dec. 12, 2024

(51) Int. Cl. H04L 9/40; G06Q 30/0251

(52) U.S. Cl. CPC H04L 63/105; G06Q 30/0251

(57) ABSTRACT

The invention relates to a system and method for allowing differing levels of privacy for a user's interaction with a website such that with a higher privacy level, user profile data is maintained on the user's client rather than being sent to a Webserver and information from the Webserver is locally processed based on the stored profile data to determine information to be presented to the user. The user profile data may then be sent to the Webserver when the privacy level is set to a higher level.

This invention relates to managing and storage of user profiles on and off client devices

The invention is of use in website monitoring, customer profiling, “know your customer”, and managing customer experiences, but can also have other uses.

### BACKGROUND OF THE INVENTION

Customer profiling in itself is now fairly commonplace. Customer profiling is used to understand the interests, propensities and behaviours of individuals on an organisation's digital channels (primarily web and mobile but may include additional data sources such as financial payments). Customer profiling helps to understand each individual and ultimately improve their customer experience by providing a personalised customer journey.

What is now generally considered to be the method of choice for such monitoring is a technique which may be described as involving “client-side page tagging”. These techniques in themselves are well understood and one such technique has been used for some time by the Applicants. An early version of this technique is explained in detail in the Applicant's earlier applications WO01/69412 and WO01/69386. In such techniques it is now typical to put some code (for example JavaScript) in some or all of the pages of a website. As each page is visited this script causes there to be communication with a server responsible for the collection of events describing users journeys/interactions with the website and managing any necessary interaction with the client.

This approach however means that scripts running in one page during a visitor's use of a monitored site will have no way of communicating with scripts running in previous or subsequent pages viewed during the visit. This necessitates a mechanism that can link the data from such a sequence of pages into one “session”. The maintenance of this “session continuity” has been commonly achieved via the use of cookies, where the cookie is used to store or reference a session ID. Cookies are generally only accessible within the domain in which they are set.

Here and throughout the specification, the expression “domain” is used in the sense used in relation to the Internet and “domain names”. Thus a domain is defined by an internet address xxx.com or xxx.co.uk and so on, i.e. by a top-level domain name.

Cookies can be set or read by scripts running in the client browser, or by a webserver communicating with the client.

Two types of cookies exist, these being first and third party cookies. First party cookies are cookies that have been set within the domain of the page being viewed. This can be achieved by using either scripts executing within the page or by the webserver(s) that are in the domain of the current page through the use of HTTP “set cookie” headers.

As security and privacy become more significant issues and the ability of users to decide whether information is shared and actively selecting to do so, the ability of websites to monitor the activity of a user visiting a website becomes harder. Whilst there may be legitimate concerns which cause users to withhold permission to allow access to their activity, it can also have a negative impact on the user experience which could allow for a more tailored presentation of information to each user. Withholding of such activity information may prevent webservers from being able to customise content supplied to a user.

Modern data protection regulations such as the EU's General Data Protection Regulation (GDPR) and similar privacy regulations, have introduced many new controls around the collection and processing of personal data. GDPR defines six legal bases which permit when personal data may be collected and processed. These include contract, legitimate interest and public task. From a marketing perspective, consent is the key legal basis. Consent under GDPR operates such that a visitor to a website is opted-out by default and must explicitly opt-in before data collection and processing of their personal data may proceed.

Article 4(11) of the GDPR states “Consent of the data subject means any freely given, specific, informed and unambiguous indication of the data subject's wishes by which he or she, by a statement or by a clear affirmative action, signifies agreement to the processing of personal data relating to him or her”.

Having provided this option to users, generally the average opt-in rates for websites is very low, sometimes as low as 5%. This low level of opt-in perhaps reflects a mis understanding of the risks or downsides of doing so.

When a user chooses to opt out of allowing their data to be shared, a first-party cookie is typically set on the client device that informs the webserver of this selection. That cookie can then be read immediately on the next page loaded, and instructs the webserver not to execute the specific functions or load third-party libraries.

Users may be allowed to select a permission level. Depending on the selected permission level, the customer profile stored on the webserver reflects the data collected about them and it may contain different types of personal information, or if they select to opt out of tracking completely, they will have no profile at all. If the visitor does not opt out of tracking, their profile will gradually grow as more information about them is gathered.

In view of the low opt-in level, a significant number of visitors are therefore not presented with personalised messages or content. This prevents the webserver from providing a more tailored and potentially beneficial experience for the user.

When a user visits a website, their client device will initially issue a request to the hosting webserver. The server will respond with the requested page which may include code (e.g. JavaScript) which can interact with the user and the client device. This will typically involve displaying information representing a web page but may carry out other functions such as gathering information from the client to be returned to the webserver. If the user has visited the site before, such client information may include cookies which may have been stored on the client device that can be used to identify the client and the user to return information back to the webserver. This allows the webserver to tailor any response according to the previous information stored in the cookie. This might include user preferences including their privacy settings, security information, tailored content and so on.

If a user has adjusted their privacy and security settings for the website to prevent some or all non-essential cookies from being used, then the return of information to the webserver may be significantly reduced to only include essential elements such as the users privacy settings. The webserver is thereby prevented from tailoring the user experience. Whilst this serves the purpose of being able to control privacy, it tends to do so in an “all or nothing” way preventing functionality that may be useful to the user without compromising the security and privacy benefits the user wishes to have. In an attempt to secure their privacy, they may undermine the ability of the website to tailor their experience.

The present invention aims to improve or alleviate this problem in providing the ability to provide a more tailored experience for a user whilst still allowing them to control the transmission of information about them and their web session from their device and how their personal information is managed.

The invention provides a way to personalise the customer experience of website visitors even when they have opted out of allowing the use of some non-essential cookies. This enables webservers to provide a better user experience to a major segment of their customers who would otherwise not be treated.

The invention is directed at managing data, which is desired to be controlled, primarily due to privacy reasons where the user may not wish data which might be considered private or sensitive to be disseminated. However, the invention is applicable to any kind of data that is to be controlled. So whilst data may be categorised to have some measure of privacy, or not, and managed accordingly, this could be applied to other types of data that are to be protected according to different criteria. As such references in this application to privacy and security of data are used interchangeably to refer to the concept of controlling data where dissemination is to be controlled and the invention is intended to cover any kind of controlled data including but not limited to data considered to be privacy data.

### SUMMARY OF THE INVENTION

Therefore according to the present invention, there is provided a method for controlling a server according to a control level indicative of whether one or more restricted data types is available to the server, the method comprising controlling said server to: determine said control level relating to a request from a client device; prepare a response in reply to said request; and send said response to said client device, wherein where said control level indicates said restricted data type is available to said server, said response is prepared on said server utilising restricted data available to the server, and where said control level indicates said restricted data type is not available to said server, said response is prepared to include reference data, such that a script when run on said client device is arranged to select from the reference data based on restricted data stored on said client device to produce a finalised response to said request, and wherein, in response to a change in the control level, said server is controlled to carry out at least one of the following steps: when said control level changes to a lower level, restricted data received from a client device is stored to be used in preparing future responses; and when said control level changes to a higher level, restricted data available to said server is sent to said client device.

The present invention also provides a method for controlling a client device according to a control level indicative of whether one or more restricted data types is available to the server, the method comprising controlling said client device to: send a request to a server; receive a response from said server; and process said response from said server, wherein when said control level is indicative of said restricted data type not being available to said server, said response is processed by a script selecting from said reference data sent from said server based on restricted data stored on said client device to produce a finalised response, wherein, in response to a change in the control level, said client device is controlled to carry out at least one of the following steps: when said control level changes to a higher level, restricted data received from said server is stored to be used in processing future responses; and when said control level changes to a lower level, stored restricted data is sent to said server from said client device.

The present invention further provides a method for controlling a system for processing requests from a client device to a server, according to a control level indicative of whether one or more restricted data types is available to the server, the method comprising: sending a request from said client device to said server; determining at said server said control level relating to said request; preparing a response in reply to said request; sending said response to said client device; receiving said response at said client device; and processing said response on said client device, wherein where said control level indicates said restricted data type is available to said server, said response is prepared on said server utilising restricted data available to the server, and where said control level indicates said restricted data type is not available to said server, said response is prepared to include reference data, and said response is processed on said client by a script selecting from said reference data based on restricted data stored on said client device to produce a finalised response; wherein, in response to a change in the control level, at least one of the following steps is carried out: when said control level changes to a lower level, restricted data stored by said client device is sent to said server and is stored to be used in preparing future responses; and when said control level changes to a higher level, restricted data available to said server is sent to said client device and stored on said client device to be used in processing future responses.

Preferably a user selection is obtained to determine the control level. The user can therefore set the control level according to the level that they wish which may be different for different servers or websites.

The control level may be modified based on parameters determined by at least one of said server and said client device. For example, the geographical location of the client device or server may be used to manage the control level so that local regulations can be factored into the operation of the system. The location may be determined by either or both of the client device and server.

The restricted data may include multiple sets of data types with each set of data assessed according to the control level so that each the sets is assessed and selectively treated accordingly. So restricted data may include two types or sets of data with different control levels so that if the control level is set to a certain value, then one of the sets is treated one way and not stored on the server and processed by the client device whilst the other set of data of freely stored on the server to allow the server to process the restricted data in that set.

When the control level changes to a higher level, for example because the user has changed their mind, then data can be transferred to the client and deleted so that it is no longer available to the server. As the data may not be stored on the server itself, it may be deleted from a storage used by the server.

The response preferably includes information for constructing a web page at the client device. The request is preferably a request for a web page. However, the invention may be used in situations where the request is not a conventional web page request and may be an interaction between an app running on a client device and the response may not be a typical web page response such HTML and Java script but may take other forms such as data to allow the code in an app to process data.

The present invention also provides a server operating according to a control level indicative of whether one or more restricted data types is available to the server, the server comprising a controller arranged to: determine said control level relating to a request from a client device; prepare a response in reply to said request; and send said response to said client device, wherein where said control level indicates said restricted data type is available to said server, said controller prepares said response utilising restricted data available to the server, and where said control level indicates said restricted data type is not available to said server, said controller prepares said response to include reference data, such that a script when run on said client device is arranged to select from the reference data based on restricted data stored on said client device to produce a finalised response to said request, and wherein, in response to a change in the control level, said controller carries out at least one of the following steps: when said control level changes to a lower level, restricted data received from a client device is stored to be used in preparing future responses; and when said control level changes to a higher level, restricted data available to said server is sent to said client device.

The present invention also provides a client device operating according to a control level indicative of whether one or more restricted data types is available to the server, the client device comprising a controller arranged to: send a request to a server; receive a response from said server; and process said response from said server, wherein when said control level is indicative of said restricted data type not being available to said server, said controller executes a script to process said response by selecting from said reference data sent from said server based on restricted data stored on said client device to produce a finalised response, wherein, in response to a change in the control level, said controller is controlled to carry out at least one of the following steps: when said control level changes to a higher level, restricted data received from said server is stored in storage on said client device to be used in processing future responses; and when said control level changes to a lower level, restricted data stored on said client device is sent to said server by said controller.

The present invention further provides a system for processing requests from a client device to a server, according to a control level indicative of whether one or more restricted data types is available to the server, comprising a client device and a server, wherein: said client device is arranged to send a request to a server; said a server is arranged to determine said control level relating to said request; said server prepares a response in reply to said request; said server sends said response to said client device; said client device receives said response; and said client device processes said response, wherein where said control level indicates said restricted data type is available to said server, said server prepares said response utilising restricted data available to the server, and where said control level indicates said restricted data type is not available to said server, said server prepares said response to include reference data, and said client device processes said response by a script selecting from said reference data based on restricted data stored on said client device to produce a finalised response; wherein, in response to a change in the control level, at least one of the following steps is carried out: when said control level changes to a lower level, the client device sends stored restricted data to said server and said server stores it to be used in preparing future responses; and when said control level changes to a higher level, said server sends restricted data available to said server to said client device and said client device stores said restricted data on said client device to be used in processing future responses.

The methods and server/client device may be implemented as computer programs comprising code portions which when loaded and run on a computer device cause the computer device to execute the method and/or cause the computer device to constitute a server/client device, such as those described above.

In this specification, the expression client is used to refer to a software implemented tool that runs on a client device and allows a user to load and display web pages, a common example of a web client is a browser-such as Chrome, Edge, Internet Explorer and so on.

In this specification, the expression client device is used to refer to any physical piece of equipment which may be used to access web pages-typically via the Internet. Example web enabled devices include personal computers (be these PCs, Apple Mac, or any equivalent), mobile (cell) phone devices, tablet devices, and so on.

In this specification, the expression server is used to refer to any physical piece of equipment which is arranged under the control of software to operate as a server for communicating with the client device, in particular for the distribution of web pages.

The client and server devices on which the present invention can be embodied will typically include a collection of the conventional parts of computers such as memory, hard drives or solid-state drives, video cards, motherboards, processors, power supplies, output devices—e.g. Monitor/screen, speakers/headphone connection, input devices—e.g. keyboard, mouse, touch screen and so on.

Note that, in general terms and with any necessary modifications in wording, all the further features defined above following any aspect of the invention above are applicable as further features of all other aspects of the invention defined above. These further features are not restated after each aspect of the invention merely for the sake of brevity.

For the avoidance of doubt, in the present invention it will be appreciated that there may be some types of essential data which it is always permissible to send to the webserver regardless of the defined level of privacy or security in the system. Furthermore, there may be certain types of data that are never sent to the webserver. Between those, are what might be described as controlled data which may be selectively sent or not. As noted above, there may be various categories of such controlled data that may be allocated different levels of privacy/security which according to the user (or other e.g. geographical) restrictions may or may not be sent to the web server. These levels may be differentiated in different ways for different types of user, preference, type of webserver, specific webserver/websites, geographical restrictions, etc. For example, certain types of controlled data may be permitted to be sent on the basis of a given user level in one jurisdiction but restricted in another. As a further example, certain types of data may be permitted to be sent on the basis of a given user level for a certain category (e.g. banking) of website but restricted for others.

These control levels used may be a simple yes or no to controlled data. In this case only essential data is sent when the control level is high (cf. opted-out below). When the control level is low (cf. opted-in below), then essential data and other controlled data can be sent, i.e. everything except any data that is never permitted—see above. Where multiple control levels or categories are in use, then controlled data may be filtered according to the more complex rules to determine if it can be sent.

### BRIEF DESCRIPTION OF THE DRAWINGS

The present invention will now be described in more detail by reference to the attached drawings in which:

FIG. 1 shows a typical layout of a system used in the invention;

FIG. 2 shows a flow chart of the interaction between a client and server;

FIG. 3 shows the flow of information between client and server when opted-in;

FIG. 4 shows the flow of information between client and server when opted-out;

FIG. 5 shows the flow of information between client and server when opting back in;

FIG. 6 shows the flow of information between client and server when opting out; and

FIG. 7 shows an arrangement using a third party hub.

### DETAILED DESCRIPTION

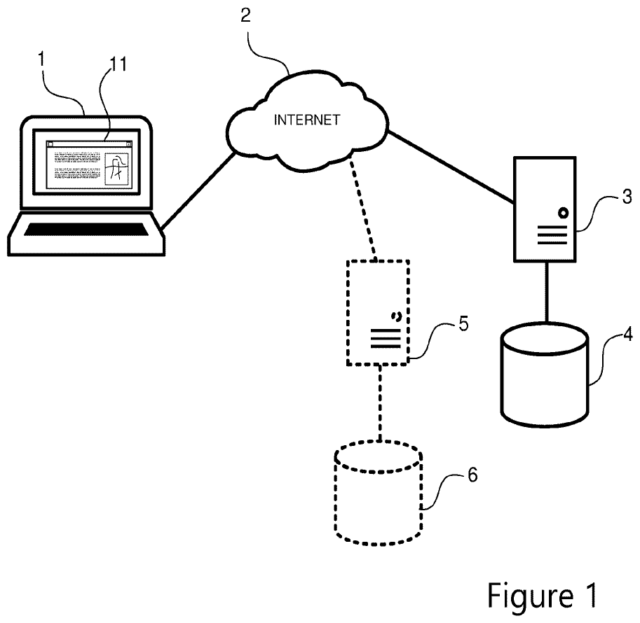

FIG. 1 schematically shows an architecture of a web-based system for monitoring user interaction with a web enabled user client device 1. The client device 1 is connected via the internet 2 or similar network to a web server 3 which may include a store 4 for providing web pages to the client device 1. The web server 3 is arranged for sending configuration messages to the web enabled device 1 and for collecting monitoring information initially collected at the client device 1 and sent to web server 4. Alternatively, rather than the web server 3 collecting the monitoring information, a separate configuration and collection server 5 may be used, with suitable storage 6. The web enabled device 1 is connected via the internet 2 to the configuration and collection server 5 which is arranged for sending the configuration messages to the client device 1 and for collecting monitoring information collected at the client device 1. In this document reference to webserver may refer to a single server carryout the process of issuing web pages and collecting monitoring information or may refer to multiple server entities, such as shown in FIG. 1, with separate server entities carrying out different tasks such as serving web pages and collecting and managing monitoring information.

In the architecture shown in FIG. 1, only one client device 1 is shown but it will be appreciated that in a practical system there may be multiple client devices 1, each of which is appropriately connected via the internet 2, to the web server 3 and/or configuration and collection server 5. Further, in the architecture shown in FIG. 1 there is a single web server 3 and it will be appreciated that in a practical system there may be multiple web servers each connected to the internet 2 and thus each accessible from the client device 1 and also accessible from any further client devices.

As mentioned in the introduction the (or each) client device 1 may be in the form of one of a number of different types of web enabled device—for example, a desktop PC or mobile communication device (i.e. mobile phone or cell phone) or a laptop as schematically indicated in FIG. 1. The web server 3 and configuration and collection server 5 are implemented on one or more server devices. Again, as mentioned in the introduction, the or each server device will comprise at least one conventional computer arranged under the control of software.

The client device 1 is arranged under the control of software to facilitate its communication via the internet in the conventional fashion. Furthermore, the client device 1 is arranged to run a web client, typically a web browser, for loading web pages supplied by the web server 3 and displaying these web pages 11 to a user. Furthermore, the client device 1 is arranged for running a client-side module within the web client. Typically, this client side module will be arranged to be able to run within a web page supplied from the web server 3. In particular, this client-side module is, in the current embodiment, arranged to execute a piece of script code in a web page 11 supplied from the web server 3, primarily for communicating with the server entity responsible for collecting and managing monitoring information, i.e. server 5 in FIG. 1 but it could be a consolidated server 3 for issuing web pages and collecting and monitoring information.

The client-side module may be provided as part of the requested web page and provided from the web server 3. That is to say the web page 11 is delivered from the web server 3 to the client device 1 and this web page 12 includes the code.

Without privacy/security (or similar) restrictions, i.e. an opt-out, a webserver (or an intermediate third party) can capture data provided from rendered web pages using the client-side module or similar, to execute code such as JavaScript. This JavaScript collects data about a user's behaviour, customer experience, device characteristics and so on and provides it back to the webserver.

When a user opts out, vendors/website operators immediately stop all data collection. No further data collection, profiling, or personalisation of the customer experience for marketing purposes is subsequently possible unless or until the user opts back in. In this way, when a user requests a webpage, it is loaded from the webserver and any stored cookies may be accessed where it will be identified that the user has opted-out. In that situation, only minimal data including that the user is opted-out is sent back to the webserver.

In order to address this, once the user/client opts out of data collection, the webserver switches to an alternative mode of operation (referred to herein as a “privacy mode”). Instead of using information fed back from the client to prepare a tailored response based on the received information and possibly information stored by the webserver, this is now not possible as the webserver is now not able to tailor the response based on stored information from the client. Instead, in privacy mode, the webserver must operate in a “blind” environment where it cannot obtain information (other than essential data) from the client but is still able to send information to the client.

The webserver therefore changes the code it sends to the client such that instead of passing information gathered at the client back to the server, data is retained on the client device and stored in local storage available to the browser (e.g. stored in the browser's persistent memory for example using the “localStorage” mechanism), or other device e.g. app, rendering the web pages. Such local storage is retained even after the web session is ended and the browser is closed. This allows the information to be recovered during a subsequent session, in a similar way to how cookies are retained between sessions. Other methods of storing data for this are possible. For example, modern devices have a Trusted Platform Module (TPM) which are typically used to store encryption keys but it could actually serve as a secure vault for the individual's client profile. Similarly, Windows® Vault is another secure location where a client profile could be stored.

In this “privacy mode” of operation, user actions, inputs and behaviours are captured and stored on the client device rather than being passed to the webserver which would be contrary to the user's desired privacy settings. When the privacy mode is active, no data used for marketing activities is passed from the client device to any external device or server but instead all data is stored securely on the client device. This information is collected and forms part of a local user profile. In this context, the user may not necessarily be an identified person, so the term user may simply be associated with a specific client device or user instance on a device.

The user profile may contain various sorts of data relating to different aspects of the session, such as the user, the session itself, consent information, client device information, location, history, transactions etc.

The table below provides a non-exhaustive example of some of the data features that might be used to form a profile:

| FEATURE | DESCRIPTION |
|---|---|
| Behaviours | Behaviours configured for the website or mobile application. |
| Campaign | Names and types of marketing campaigns. |
| Device | Device information such as system type (for example: mobile, PC, |
| | or console). |
| Downloads | Details or references of content downloaded by the visitor. |
| Goals | Any visitor goals which should be highlighted. |
| Media | Name or reference of video clips viewed by the visitor. |
| Personalisation | What triggers, actions and content have been applied to a visitor. |
| Products | Products viewed and a count for the number of distinct views. |
| Promotions | Promotions viewed by the visitor and a count for each. |
| Purchases | Purchase orders with total value in base currency. |
| Signals | Signals generated by machine learning models. |

The profile may therefore form a combination of fixed facts about the user such as usernames, specific details, preferences, device information etc. but may also include historical use information such as pages that have been viewed and when, information about how the user interacts with the webpage, location of the device over time, and so on. This information may be stored as a sort of log in the profile with varying degrees of detail as required, to build up the profile over a period of time.

Once the user has opted to have a high privacy setting, when they next engage with a website, the webserver will not have access to the data stored on the client device and so no non-essential data is returned to the webserver. As noted above, this prevents tailored information being provided to the client from the webserver. Instead, when the user accesses the website, the user's status, i.e. privacy mode, is returned to the webserver and so it operates based on that privacy mode.

In this mode, as the webserver is unaware of the specific characteristics of the user it must therefore treat the user as a generic user. It therefore responds by sending a collection of information back to the client device which represents a range of options and information which can be used to provide user content. That may include programs, such as Javascript, that carry out processing by reference to the data stored as the profile on the user device. In this way, the information presented to the user can be controlled accordingly and the operation of the rendered webpage and the output is individualised according to the locally stored profile data.

For example, the information sent from the webserver may include a control program and other data, such as a selection of advertisements which may be appropriate to a range of interests. Once the control program is run on the client device, it assesses the information held in the locally stored data and may establish that the user has been looking at particular types of information such as cars or some related items. The program may then determine that one of the many adverts sent relates to a car advert and may therefore determine that the advert could be presented to the user as it may be relevant to their current interests. In this way, the on-device data is used to make decisions on improving the user's customer experience, such as offers and messages, which reflect their interests and behaviours.

In another example, the user accesses a webpage where they have chosen a high privacy level, and so the webserver responds as before with a selection of information. In this case, the information held locally is used to determine items that a user was viewing on a retailer website and can then return the user to a page previously being viewed and populate a basket with items previously gathered. None of this information is sent to the retailer website (until of course, the user wants to submit an order).

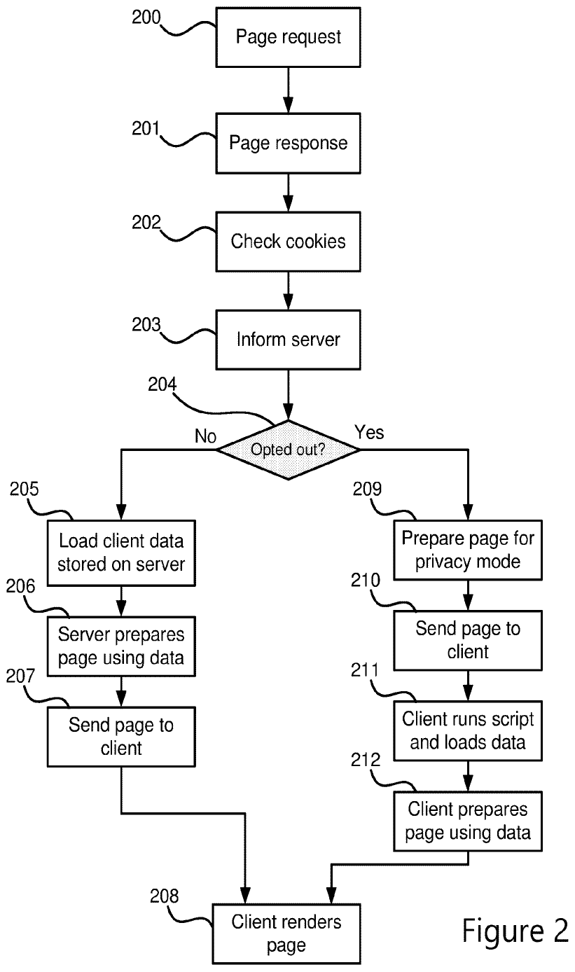

FIG. 2 shows a flow chart of the process for accessing a web page by the client device. For example, the user wants to access a page at abc.com. At 200 a web page request is prepared to be sent to the webserver. This is passed to the webserver in the usual way by resolving the address of the server and passing the request on. When the request is received, the webserver processes the request and prepares a response with the appropriate page information at 201. This is sent back to the client device which processes the response to determine if there are any cookies present and in particular will check to see if there is any cookie relating to the privacy requirements of the user for this site. At 202, the cookies are checked and a response is provided to the server accordingly at 203.

On the server, the response is assessed and at 204 determines what the privacy settings are for that user and/or device combination. In this example this is determined to be a simple Yes or No to whether the client/user has opted out of allowing data to be stored on the server. If the privacy level is set to a lower level, i.e. the user has not opted out, the server prepares 205 collects data on the user which has been stored on the server (or elsewhere, e.g. a separate store for user data) previously. The server then prepares a page 206 to be presented to the user based on the stored data. This may include script for presenting the page and interacting with the user. The prepared page is then sent to the client which renders the page 208. This provides a presentation to the user which is tailored to them based on data relevant to them stored on the server (although some or all of it may be stored on the client)

At step 204, if the user has opted out, then the server will continue to step 209 to prepare a page based on there being no user data available. This may include collating a number of possible options that might be presented to the user depending on data stored on the client itself. The page will include a script to be run to determine the pages to be rendered to the client based on the local data stored on the client. The page is then sent 210 to the client device which runs the script 211. The local data on the user/client will loaded as the script is run and, based on the data, a page will be prepared 212 which is tailored based on the stored data on the client. Finally, the user will be presented with the page 208.

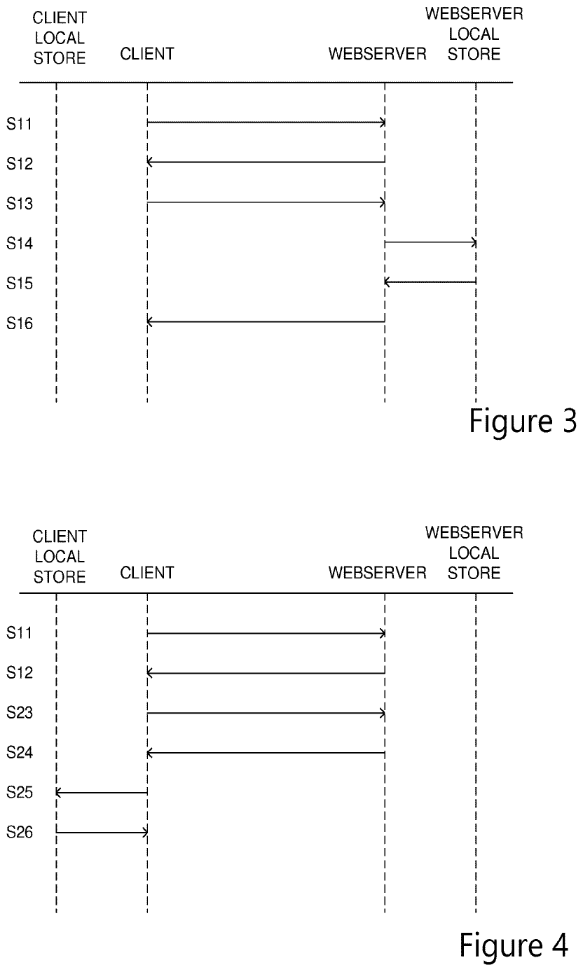

FIG. 3 shows the basic interaction between the client and webserver when the user has not selected a high privacy level. At step S11, the user initiates the client to request a page from a webserver. The request is sent to the webserver which responds to the initial response at step S12. The client processes the response and provides its own response at step S13 which may include information about the user and their preferences, previous usage etc. from the local store and/or stored cookies. In this example, the user has not selected high privacy by opting out and so the webserver has information about the user which it requests from its own local store at step S14. At S15, the information is retrieved and the webserver can then construct the web page to be sent to the client at step S16. This is then rendered by the client to the user, providing a tailored response based on the information held by the webserver.

FIG. 4 shows the alternative situation where the user has selected a higher privacy level by opting out. As before, at step S11, the user initiates the client to request a page from the webserver. The request is sent to the webserver which responds to the initial response at step S12. The client processes the response and provides its own response at step S23 which in this cases identifies the client as having opted out. The response does not include restricted private information about the user but instead provides only essential data, which should include the user's opted-in or out status. In this example, the higher privacy setting means the webserver will not have any previously stored information about the user (or at most only essential data). Alternatively, the server may have minimal essential data about a user, including their opted-in or opted-out status. In that way, rather than the client device providing the opted-in or -out status, a client identifier may be sent to identify the user and the server then determines the consent status. This could happen, for example, if a user calls a contact centre and specifies their consent status to a call centre agent, who records it against the user's profile. When the user subsequently goes into the mobile application or website, the server can determine the consent information and potentially pass that information to the client device.

The webserver must then construct the web page to be sent to the client at step S24, using the generic approach described above, to include the selection of pages and information to be presented to the user. This is received from the webserver at S24 at the client. The client then requests the information held in its local store at step S25 which is returned at step S26. This is then processed as described above based on the local data, which is then rendered and presented to the user providing a tailored response based on the information held by the client.

Although the data sent from the webserver may contain a lot of information such as adverts, many of these may never be presented to the user because they are not deemed relevant based on the data stored in the local profile. The unused data may therefore be discarded as unnecessary or retained in case they become relevant later on.

All of this is carried out on the client device with no information from the local store needing to be passed back to the webserver and thereby preserving the privacy of that data. Once the advert etc. has been presented to the user, they may elect to follow a link to a relevant website page which would then be accessed in the usual way.

The program operated on the client device may also note other actions of the user to update the information stored in the local storage based on the current interaction. This allows the stored information to be updated. Other housekeeping tasks may be carried out such as deleting data no longer required or updating information already held.

In this way, the information stored can be maintained in a similar way as if it was stored on the webserver but without ever passing the information to the webserver. The rules which dictate how the program operates to decide what personalised content to present are evaluated entirely on the device and no feedback nor other signals (other than essential data) need be sent, at any point, to another device. The script loaded with the webpage from the server may be stored in the local storage along with the data, to provide ongoing management of the data between sessions. The script may then be run periodically (e.g. during a session, or on a daily basis) to manage the stored data. Alternatively, the script may be loaded on a first occasion and then reutilised on a subsequent occasion with being downloaded again.

The rules which control personalisation based on user behaviours can be hard coded into the website application (i.e. the information provided by the website to the client including the script which does the on device implementation along with the other webpage elements) or provided dynamically when the visitor arrives on the website. They may also be periodically updated during the visitor's browsing session.

The ability to continue to provide tailored functionality to a user even though they have chosen a high privacy setting is clearly advantageous and provides entirely one-way transmission of data from the webserver to the client and so is essentially sending information blind and relying on the program running on the client device to make use of the data with little (other than pages requested by the client and any essential data required) or no feedback.

Whilst the above system allows the user to be presented with a tailored experience, it does involve sending data that may not be used and restricts the feedback to the webserver which may restrict the interactivity of the process. It is therefore still generally preferable for the webserver to have a more active interaction with the data and ideally be able to access the information about the user stored on the client, as in the case where the user had opted in.

To benefit from the improved experience, users may elect to opt-in again to allow information to be sent to the webserver to permit processing there and the associated benefits. However, whilst the user has been opted out, no information is stored at the webserver and so it would need to reconstruct the data needed to tailor the experience which may take time and require the user to provide some aspects of that information such as personal preferences etc.

Therefore, if the user opts back in to allowing data collection and processing on the webserver then according to the consent granted by the visitor, the on-device data stored at the client can be sent to the webservers to enhance their existing or a new profile. In this way, the useful profile information gathered whilst the user is opted-out can be preserved allowing the webserver to provide the enhanced user experience available by processing data at the webserver without having to rebuild the profile at the webserver.

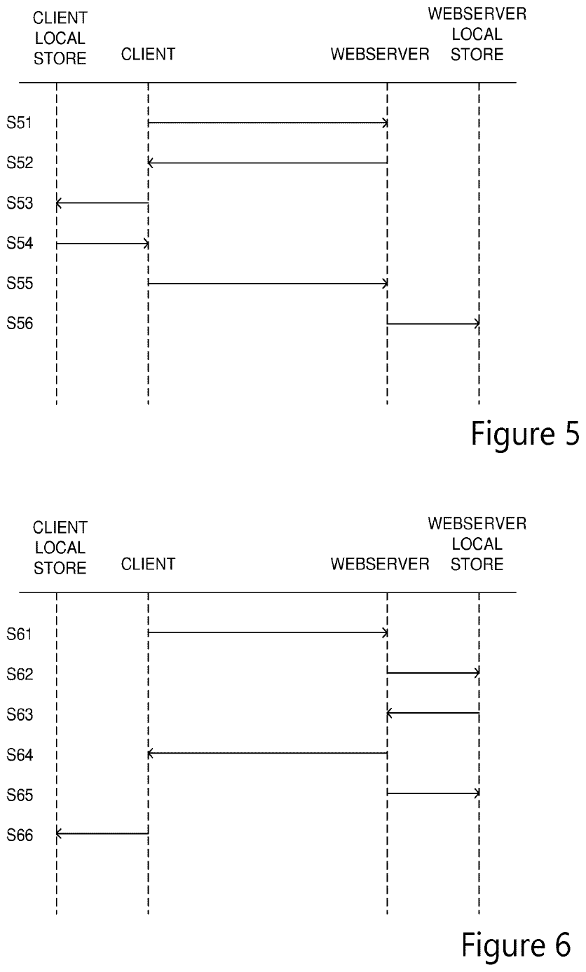

FIG. 5 shows a typical process for opting back in. At step S51, the client indicates to the server that the user has decided to opt in. The server responds S52 by requesting the user profile stored on the client. The client then requests the stored profile information stored on the client device S53 and the data relating to the user/client profile is returned S54. The client then sends the profile information it has collected to the server S55. The server then stores the prolife information in its own storage S56, which may be on the server itself or a separate store, or even a third party storage. Steps S51 and S52 may be omitted with the client initiating step S53 when the user opts in, to collect the user profile and then sends it to the server at step S55, which also serves to inform the server of the change of status.

Similarly, at the point a user decides to opt out of allowing server-side data collection and processing, to reflect the higher security settings, the webserver may have to remove some or all of the stored profile data. Rather than simply discarding the existing information stored at the server, it may be transferred either partially or completely to the user's client device. This allows the existing profile information on the server to be preserved and stored by the user on their own client. This respects the users higher privacy requirement by removing the data from the server but still preserves the value in the profile.

FIG. 6 shows a typical process for opting out. At step S61, the client indicates to the server that the user has decided to opt out. The server notes the change of status and requests S62 the profile data it has stored on the webserver storage. As noted above, the storage may be local, as indicated, but may be held elsewhere. The profile information stored on server store is passed to the server S63. The server then sends the profile information it has collected to the client S64. The server then arranges for the stored restricted profile data to be deleted S65, so that it is no longer retained at the server side. The client stores S66 the prolife information in its own local storage.

The server therefore sends a handover message S64 which provides a pre-populated profile on the client once the user is opted out. In this way, the profile information gathered either on the server side during opted-in operation, or on the client side during opted-out operation can be transferred between the two to maintain the value in the information already collected and avoiding starting from a blank profile every time a user changes between being opted-in or-out.

In the above, the user is either opted in or out but a hybrid version may be provided where certain types or data are not returned to the server but some types of data are. In this sense, the user agrees to certain types of data being sent to the server, perhaps basic data such as name, website preferences, etc. but other more sensitive data such as national identification numbers or other confidential information are not passed to the server. In this hybrid approach, the webserver may be able to prepare a partially bespoke response based on the information it is able to receive and then send a response with multiple options (similar to the opted-out option) which can then be further processed at the client to provide the final output based on the more sensitive data held only at the client.

In the examples above, the user is able to control the level of privacy from only allowing essential data to be stored at a server (opted-out) to allowing largely unlimited storage of data at the server (opted-in), or some middle ground where some data may be stored but other data is only held locally. Each piece of data or data type may be given an individual security sensitivity level. Equally groups of data may be categorised in this way. According to the sensitivity level, each piece of data may be treated differently. For example, country information may be low level, an IP address may be middle level and postcode and sexual orientation may be high level. Depending on the security level currently set, different data may be treated differently so IP address and date of birth may be retained in the local storage whilst country is sent to the webserver but at higher levels nothing is sent to the webserver.

Some countries may have stricter laws than others and so depending on where the user and webserver is located, may require some degree of minimum mandatory privacy level. Some countries may prohibit transmission of certain information irrespective of consent whereas other countries may be more permissive or defer choice to the user. In this way, the user's location may also affect what information is transferred with some being stored locally. In other words, the privacy or security level may be elevated based on geographical location as well as user preference.

For example, if a user is opted-in and is based in country A which has permissive rules, then data may be freely stored on the server. However, if the user travels to country B where the rules are more restrictive, then the system may adapt accordingly to restrict some of all of the data from being sent to the webserver but instead storing it locally on the client device.

The hybrid approach allows the webserver to access some information which may allow it to filter the information sent to the client device which may then carry out more filtering based on the information stored locally. In this way the more effective filtering can be carried out at the server, minimising the data that is sent to the client based on the initial filtration and thereby allowing a more refined set of data for the on-device filtering to utilise. This can still be done whilst respecting local laws.

Again, where the user changes their privacy/security settings, the superset of data on both the client and server can be transferred to one of the other of the client (for high privacy/security settings) or to the server (where the privacy requirements are lower). This may also be applied where the jurisdictional provisions change. For example, when a user using their device in a strict (high privacy requirement) jurisdiction, then data may not be sent to the server but instead stored on the client. However, if the user then travels to a different jurisdiction where the provisions are less, and assuming the user's own options are also to opt in, then the data stored on the client may be transferred to the webserver to aggregate with data already stored from a previous time. The data on the server may also be transferred to the client such that if they return to the more restrictive jurisdiction, the system can return to the opted-out way of operating and utilise the processing of data sent to the client device without sending data back to the webserver. This allows the highly tailored functionality to be maintained.

As noted above, the aggregated data may be stored in one or both of the client and webserver or partial profiles may be stored to reflect intermediate privacy settings/requirements.

In the above examples, a simple client and webserver arrangement is described but it will be understood by those skilled in the art that the interactions may be considerably more complex with the webserver representing multiple servers or intermediaries with processing of data and rendering of pages carried out from multiple sources. However, the principles are the same with data being quarantined to within locations selected by the user and/or controlled by national requirements based on the client or server location, in order to limit where the private data can be located and accessed.

Even when opted-in, the client may store some information. For example, if the connection between the client and server is restricted due to bandwidth limitations (e.g. the user is on a 2G or 3G mobile network or a poor Wi-Fi connection) or local regulations limit distribution of certain types of data, then personalisation data may be retained on the client in a similar way to the opted-out option. This data may then be sent on to the server at a later time, as and when appropriate. In the case of limited bandwidth, this may be when a better connection can be established between the client and server. In the case of local regulatory restrictions, it may be when the client is in a different location where the transmission of the data types is again permissible. This enables useful personalisation data to be preserved and collected accordingly.

In the examples above, the control of the data is based on a specific user/client and website combination. So when a user engages with a website, they select a security setting relating to that website to allow users to control the information released to specific websites. However, the user may select a global security setting for example opting out for all websites. These options provide a simple ability to control privacy and security of data. However, this does mean that a user who does not want to have a global setting needs to specify their preference by opting in or out for each website and potentially for each device they may use.

One option to allow a more efficient control is to define categories of websites that are categorised in a particular way. For example, banking websites might be considered to be more secure (or it might be considered more desirable to share private information in terms of the benefits of doing so) and so a user may wish to opt in for all banking websites whereas retail websites may be considered less desirable to opt in to and so the user may prefer to opt out of all retail sites. In this way, rather than the user having to specify their option or out option for each website, this might be done automatically according to the user's more generic preferences.

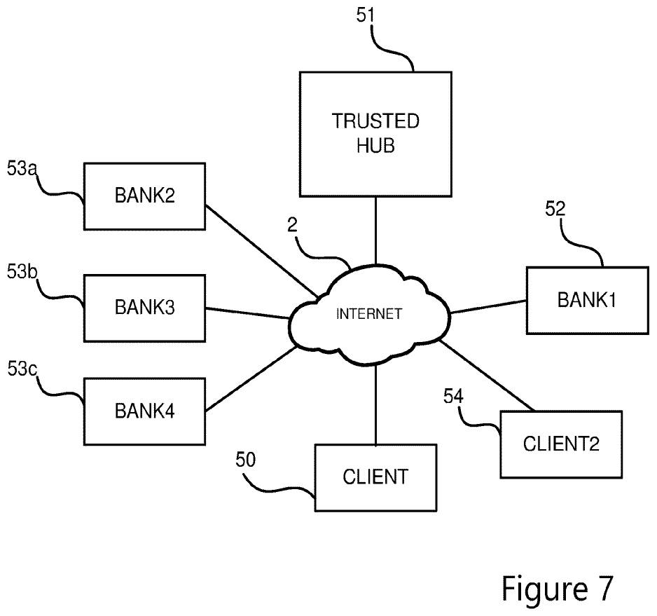

FIG. 7 shows a further development of this in which a third party trusted hub is used to manage a user's preferences. A client 50 may interact with websites 52, 53a-c via the internet 2 as described above. In this example they are banks but they may be websites providing other services such as retail services. As the client interacts with a server 52 associated with one bank (BANK1), they may select preferences and opt out of allowing their data to be stored. In the examples above, the user's preferences would then cause data on the website 52 to be cleared and restricted data sent to then be stored on the client 50. Any subsequent data is then retained on the client.

In this arrangement, the data from the server can instead be transferred to the trusted hub 51. In this way, data is not stored on the webserver but in a more controlled environment of the trusted hub which the user is able to selectively control. The user is then able to dictate how their data is shared. In this example, they may elect to provide access to their data to the website 52. In this way when the user next visits website 52, the personal data may be released to the website due to the previous permission given by the user, even though the data is not held by the website.

The user may be provided with the option to monitor what sites have what permissions by logging on to the trusted hub site. In this case, they may see that they have granted BANK1 permission to access their data (or some of it). They may also be able to see what data has been collected by that website and manage it accordingly. As a further option, the user may say that the data gather by BANK1 may be shared with other sites for example BANK2, BANK3 and BANK4. This may be convenient so that the user can obtain improved functionality from these other websites without having to grant explicit permission to each by visiting each website but instead centrally. As noted above, this may extend to granting permission to specific categories of website. So in this example, the user may log in to the trusted hub, confirm that all (or specific types of) data may be shared with other banks. In this way when the user logs into BANK3 on website 53b, the site will be able to access data stored on the hub and provide enhanced functionality even though the bank has no previous data stored about that user or permission information. Additional interactions may then add to the total set of data available to that and other sites associated in that category, in this example, all banks. That would then allow data entered when interacting with BANK 3 to be accessed by BANK1.

The trusted hub may store the actual personal data as noted above which allows the user to log in on different devices but still access their preferred associations based on the user rather than the client itself. If the user logs in from a different client 54, e.g. a mobile phone, then they can still identify themselves to the trusted hub 51 and any previous data can be accessed to make their interaction more appropriate. It also means any subsequent data collected can be used to update their profile.

In the example above, the user data is stored on the trusted hub or an associated storage device. However, the data may still be retained on the client device and the hub simply manages the permission data defining what data may be shared to what websites. In this way, in the example above, the user may define on the trusted hub that they are happy to share data with all banks. In this case all the data is retained on the client device but when the user logs on to BANK4, the trusted hub is queried and confirms that data can be shared to all banks including BANK4, so that the client 50 can then return data to the site 53c.

Data may still be collected on the client device and later shared to the trusted hub to update the user profile either in an automatic way or manually under the control of the user. The interaction with the hub may be controlled by accessing a website or via a browser plug in.

When a user has opted out to prevent data being stored on a server, the server may still want to provide data to be stored against the users profile to keep the profile up to date. If a user shows interest in a particular product, or purchases a particular item, the server may pass that information to the client to be stored against the user's profile or the client may be controlled to do that automatically. This allows the user profile to be kept up to date but without any data being provided and stored on the server. Even if some of the data comes from the server, the server must delete that information once the session is completed. So if a user enquires about a particular service, the server may not be allowed to maintain any reference to that after the session but the information can be stored at the client, so that on the next visit a more tailored approach can be provided to the user.

Information stored may also be contemporaneous or reflective of the location or environment of the user. For example, if the user looks at a website regarding train tickets, the time and day may also be automatically recorded to reflect the temporal information and the location of the user may also be recorded. The server may not control this but instead the client may implement that automatically. When the user next visits the website and is in a similar location at a similar time, then they may be present with a ticket reflecting the destination they have selected previously or provided with a discount to that location etc.

In another example, the user may buy ice cream which can be recorded (for example a banking application sees the contactless card transaction come through for the ice cream purchase or perhaps is purchased within an application such as on a retail website) and sent to the client to be stored against the user profile. The client device may also utilise third party data sources to add to the attributes in the user profile. For example, the client device could call a third party API and obtain the current weather at the user's location. That would be combined in the local profile with the recent purchase (an ice cream). Together that information allows good personalisation decisions to aid in improving the users tailored output. For example, when the weather is warm, the user may be shown a message about ice creams.

The examples above refer primarily to interactions between a user and website using a browser but it will be understood that the invention applies equally to other methods of user interaction, such as apps running on devices e.g. Android®, Windows®, iOS® etc.

Such apps can interact with websites or other servers and may store local data to provide similar functionality.

1. A method for controlling a server according to a control level indicative of whether one or more restricted data types is available to the server, the method comprising controlling said server to:
determine said control level relating to a request from a client device;
prepare a response in reply to said request; and
send said response to said client device,
wherein where said control level indicates said restricted data type is available to said server, said response is prepared on said server utilising restricted data available to the server, and where said control level indicates said restricted data type is not available to said server, said response is prepared to include reference data, such that a script when run on said client device is arranged to select from the reference data based on restricted data stored on said client device to produce a finalised response to said request, and
wherein, in response to a change in the control level, said server is controlled to carry out at least one of the following steps:
when said control level changes to a lower level, restricted data received from a client device is stored to be used in preparing future responses; and
when said control level changes to a higher level, restricted data available to said server is sent to said client device.

2. A method according to claim 1 further comprising obtaining a user selection to determine said control level.

3. A method according to claim 1 further comprising modifying the control level based on parameters determined by at least one of said server and said client device.

4. A method according to claim 1 wherein the restricted data may include multiple sets of data types with each set of data assessed according to said control level and said set of data selectively treated accordingly.

5. A method according to claim 1 wherein when said control level changes to a higher level and data is transferred to the client, it is deleted so that it is no longer available to the server.

6. A method according to claim 1 wherein said response includes information for constructing a web page at the client device.

7. A method for controlling a client device according to a control level indicative of whether one or more restricted data types is available to the server, the method comprising controlling said client device to:
send a request to a server;
receive a response from said server; and
process said response from said server, wherein when said control level is indicative of said restricted data type not being available to said server, said response is processed by a script selecting from said reference data sent from said server based on restricted data stored on said client device to produce a finalised response,
wherein, in response to a change in the control level, said client device is controlled to carry out at least one of the following steps:
when said control level changes to a higher level, restricted data received from said server is stored to be used in processing future responses; and
when said control level changes to a lower level, stored restricted data is sent to said server from said client device.

8. A method according to claim 7 further comprising obtaining a user selection to determine said control level.

9. A method according to claim 7 further comprising modifying the control level based on parameters determined by at least one of said server and said client device.

10. A method according to claim 7 wherein the restricted data may include multiple sets of data types with each set assessed according to said control level and said set of data treated accordingly.

11. A method according to claim 7 wherein when said control level changes to a higher level and data is transferred to the client, it is stored on the client device.

12. A method according to claim 7 wherein said finalised response includes information for constructing a web page on the client device.

13. A method for controlling a system for processing requests from a client device to a server, according to a control level indicative of whether one or more restricted data types is available to the server, the method comprising:
sending a request from said client device to said server;
determining at said server said control level relating to said request;
preparing a response in reply to said request;
sending said response to said client device;
receiving said response at said client device; and
processing said response on said client device, wherein
where said control level indicates said restricted data type is available to said server, said response is prepared on said server utilising restricted data available to the server, and
where said control level indicates said restricted data type is not available to said server, said response is prepared to include reference data, and said response is processed on said client by a script selecting from said reference data based on restricted data stored on said client device to produce a finalised response;
wherein, in response to a change in the control level, at least one of the following steps is carried out:
when said control level changes to a lower level, restricted data stored by said client device is sent to said server and is stored to be used in preparing future responses; and
when said control level changes to a higher level, restricted data available to said server is sent to said client device and stored on said client device to be used in processing future responses.

14. A method according to claim 13 further comprising obtaining a user selection to determine said control level.

15. A method according to claim 13 further comprising modifying the control level based on parameters determined by at least one of said server and said client device.

16. A method according to claim 13 wherein the restricted data may include multiple sets of data types with each assessed according to said control level and said set of data selectively treated accordingly.

17. A method according to claim 13 wherein when said control level changes to a higher level and data is transferred to the client device, it is stored on the client device and then deleted so that it is no longer available to the server.

18. A method according to claim 13 wherein said finalised response includes information for constructing a web page on the client device.

19. A server operating according to a control level indicative of whether one or more restricted data types is available to the server, the server comprising a controller arranged to:
determine said control level relating to a request from a client device;
prepare a response in reply to said request; and
send said response to said client device,
wherein where said control level indicates said restricted data type is available to said server, said controller prepares said response utilising restricted data available to the server, and where said control level indicates said restricted data type is not available to said server, said controller prepares said response to include reference data, such that a script when run on said client device is arranged to select from the reference data based on restricted data stored on said client device to produce a finalised response to said request, and
wherein, in response to a change in the control level, said controller carries out at least one of the following steps:
when said control level changes to a lower level, restricted data received from a client device is stored to be used in preparing future responses; and
when said control level changes to a higher level, restricted data available to said server is sent to said client device.

20. A server according to claim 19 wherein said controller obtains said control level from said client device.

21. A server according to claim 19 further comprising modifying the control level based on parameters determined by at least one of said server and said client device.

22. A server according to claim 19 wherein the restricted data may include multiple sets of data types with each assessed according to said control level and said set of data selectively treated accordingly.

23. A server according to claim 19 wherein when said control level changes to a higher level and data is transferred to the client device, it is deleted so that it is no longer available to the server.

24. A server according to claim 19 wherein said response includes information for constructing a web page at the client device.

25. A client device operating according to a control level indicative of whether one or more restricted data types is available to the server, the client device comprising a controller arranged to:
send a request to a server;
receive a response from said server; and
process said response from said server, wherein when said control level is indicative of said restricted data type not being available to said server, said controller executes a script to process said response by selecting from said reference data sent from said server based on restricted data stored on said client device to produce a finalised response,
wherein, in response to a change in the control level, said controller is controlled to carry out at least one of the following steps:
when said control level changes to a higher level, restricted data received from said server is stored in storage on said client device to be used in processing future responses; and
when said control level changes to a lower level, restricted data stored on said client device is sent to said server by said controller.

26. A client device according to claim 25 wherein said controller obtains a user selection to determine said control level.

27. A client device according to claim 25 further comprising modifying the control level based on parameters determined by at least one of said server and said client device.

28. A client device according to claim 25 wherein the restricted data may include multiple sets of data types with each set assessed according to said control level and said set of data selectively treated accordingly.

29. A client device according to claim 25 wherein when said control level changes to a higher level and data is transferred to the client device, it is stored on the client device.

30. A client device according to claim 25 wherein said finalised response includes information for constructing a web page on the client device.

31. A system for processing requests from a client device to a server, according to a control level indicative of whether one or more restricted data types is available to the server, comprising a client device and a server, wherein:
said client device is arranged to send a request to a server;
said a server is arranged to determine said control level relating to said request;
said server prepares a response in reply to said request;
said server sends said response to said client device;
said client device receives said response; and
said client device processes said response, wherein
where said control level indicates said restricted data type is available to said server, said server prepares said response utilising restricted data available to the server, and
where said control level indicates said restricted data type is not available to said server, said server prepares said response to include reference data, and said client device processes said response by a script selecting from said reference data based on restricted data stored on said client device to produce a finalised response;
wherein, in response to a change in the control level, at least one of the following steps is carried out:
when said control level changes to a lower level, the client device sends stored restricted data to said server and said server stores it to be used in preparing future responses; and
when said control level changes to a higher level, said server sends restricted data available to said server to said client device and said client device stores said restricted data on said client device to be used in processing future responses.

32. A system according to claim 31 further comprising obtaining a user selection to determine said control level.

33. A system according to claim 31 further comprising modifying the control level based on parameters determined by at least one of said server and said client device.

34. A system according to claim 31 wherein the restricted data may include multiple sets of data types with each assessed according to said control level and said set of data selectively treated accordingly.

35. A system according to claim 31 wherein when said control level changes to a higher level and data is transferred from the server to the client device, it is stored on the client device and then deleted so that it is no longer available to the server.

36. A system according to claim 31 wherein said finalised response includes information for constructing a web page on the client device.

37. A machine readable data carrier carrying a computer program comprising code portions which when loaded and run on a computer device causes the computer device to execute a method as claimed in claim 1.

38. A machine readable data carrier carrying a computer program comprising code portions which when loaded and run on a computer device cause the computer device to execute a method as claimed in claim 7.

39. A machine readable data carrier carrying a computer program comprising code portions which when loaded and run on a computer device cause the computer device to execute a method as claimed in claim 13.
